(19) United States
(12) Patent Application Publication
(10) Pub. No.: US 2010/0149688 A1
(43) Pub. Date: Jun. 17, 2010

(54) PERPENDICULAR-MAGNETIC-RECORDING HEAD WITH LEADING-EDGE TAPER OF A PLANARIZED STEPPED-POLE LAYER HAVING GREATER RECESS DISTANCE THAN A FLARE-POINT OF A MAIN-POLE LAYER

(76) Inventors: Quang Le, San Jose, CA (US); Jui-Lung Li, San Jose, CA (US)

Correspondence Address: HITACHI C/O WAGNER BLECHER LLP, 123 WESTRIDGE DRIVE, WATSONVILLE, CA, 95076, US

(21) Appl. No.: 12/333,094

(22) Filed: Dec. 11, 2008

(51) Int. Cl. G11B 5/127

(52) U.S. Cl. 360/125.41; G9B/5.107

(57) ABSTRACT

Perpendicular-magnetic-recording head with leading-edge taper of a planarized stepped-pole layer having greater recess distance than a flare point of a main-pole layer. The perpendicular-magnetic-recording head includes a write element including the main-pole layer having the flare point recessed a first distance from a pole tip of the main-pole layer at an air-bearing surface below the air-bearing surface. The write element includes the stepped-pole layer magnetically coupled with the main-pole layer across an interface between the main-pole layer and the stepped-pole layer. The stepped-pole layer has the leading-edge taper recessed a second distance from the pole tip of the main-pole layer at an air-bearing surface below the air-bearing surface. The second distance of the leading-edge taper is greater than the first distance of the flare point. A surface of the stepped-pole layer is planarized with the interface between the main-pole layer and the stepped-pole layer substantially flat over the leading-edge taper.

### TECHNICAL FIELD

Embodiments of the present invention relate to the field of hard-disk-drives, perpendicular-magnetic-recording heads used in hard-disk-drives and their manufacture.

### BACKGROUND

The magnetic-recording, hard-disk-drive (HDD) industry is extremely competitive. The demands of the market for ever increasing storage capacity, storage speed, and other enhancement features compounded with the desire for low cost creates tremendous pressure for developments of improved HDD design. One such development is perpendicular-magnetic recording, which offers great promise for present and future improvements in the storage capacity of HDDs.

Associated with the development of perpendicular-magnetic recording is the design of perpendicular-magnetic-recording (PMR) heads having both high efficiency and high reliability. Engineers engaged in the design of PMR heads are constantly striving to produce PMR heads that can achieve ever higher recording densities. However, the processes employed to produce such PMR heads push the frontiers of thin-film fabrication technology to limits where standard processes of the past produce artifacts affecting PMR head performance and reliability. In particular, new procedures need to be developed which overcome limitations imposed by past process technology.

### SUMMARY

Embodiments of the present invention include a perpendicular-magnetic-recording head with leading-edge taper of a planarized stepped-pole layer having greater recess distance than a flare point of a main-pole layer. The perpendicular-magnetic-recording head includes a write element including the main-pole layer having the flare point recessed a first distance from a pole tip of the main-pole layer at an air-bearing surface below the air-bearing surface. The write element includes the stepped-pole layer magnetically coupled with the main-pole layer across an interface between the main-pole layer and the stepped-pole layer. The stepped-pole layer has the leading-edge taper recessed a second distance from the pole tip of the main-pole layer at an air-bearing surface below the air-bearing surface. The second distance of the leading-edge taper is greater than the first distance of the flare point. A surface of the stepped-pole layer is planarized such that the interface between the main-pole layer and the stepped-pole layer is substantially flat over the leading-edge taper.

### DESCRIPTION OF THE DRAWINGS

The accompanying drawings, which are incorporated in and form a part of this specification, illustrate embodiments of the invention and, together with the description, serve to explain the embodiments of the invention:

FIG. 1 is a plan view of a hard-disk drive (HDD) illustrating the functional arrangement of components of the HDD including a slider including a perpendicular-magnetic-recording (PMR) head with leading-edge taper of a planarized stepped-pole layer having greater recess distance than a flare point of a main-pole layer, in accordance with an embodiment of the present invention.

FIG. 2 is a plan view of a head-arm-assembly (HAA) of the HDD of FIG. 1 including a head-gimbal assembly (HGA) illustrating the functional arrangement of components of the HAA and HGA with respect to the PMR head, in accordance with an embodiment of the present invention.

FIG. 3A is a plan view of the slider of the HGA of FIG. 2 illustrating the functional arrangement of components of the slider including the PMR head, in accordance with an embodiment of the present invention.

FIG. 3B is a magnified plan view of the slider of FIG. 3A at a trailing edge (TE) center pad of an air-bearing surface (ABS) illustrating the functional arrangement of components of the PMR head: a write element and a read element, in accordance with an embodiment of the present invention.

FIG. 3C is a plan view of the write element of the PMR head as seen in the cutting plane 3C-3C in the slider of FIG. 3B illustrating the disposition of a main-pole layer on a stepped-pole layer in the write element of the PMR head, in accordance with an embodiment of the present invention.

FIG. 3D is a detailed plan view of the main-pole layer of the write element of FIG. 3C illustrating the component portions of the main-pole layer: a pole tip, a throat, a flared portion and a yoke portion, in accordance with an embodiment of the present invention.

FIG. 3E is a detailed plan view of the stepped-pole layer of the write element of FIG. 3C illustrating the component portions of the stepped-pole layer: a flared portion and a yoke portion, in accordance with an embodiment of the present invention.

FIG. 3F is a cross-sectional elevation view of the write element of FIG. 3C of the PMR head as seen in the cutting plane 3F-3F in the slider of FIG. 3B illustrating the functional arrangement of components of the write element: the main-pole layer, a shaping layer, a taper forming layer and the stepped-pole layer with a leading-edge taper, in accordance with an embodiment of the present invention.

FIG. 4A is a plan view of a write element of a PMR head illustrating the disposition of a main-pole layer on a stepped-pole layer having a flare-extension portion with a substantially squared corner in a plane of the stepped-pole layer and a side oriented perpendicular to the ABS, a so-called “vertical” flare-extension portion, in accordance with an alternative embodiment of the present invention.

FIG. 4B is a plan view of a write element of a PMR head illustrating the disposition of a main-pole layer on a stepped-pole layer having a flare-extension portion with a chamfered corner in a plane of the stepped-pole layer and a side oriented at a skewed angle to the ABS, a so-called “tapered” flare-extension portion, in accordance with an alternative embodiment of the present invention.

FIG. 5 is a cross-sectional elevation view of a write element of a PMR head having a material-loss artifact in a stepped-pole layer illustrating the functional arrangement of components of the write element with respect to the material-loss artifact in the stepped-pole layer, which demonstrates the utility of embodiments of the present invention.

FIG. 6 is a cross-sectional elevation view of a write element of a PMR head having a material-excess artifact of stepped-pole-layer material intruding into a main-pole layer illustrating the functional arrangement of components of the write element with respect to the material-excess artifact, which demonstrates the utility of embodiments of the present invention.

FIG. 7 is a flow chart illustrating a method for fabricating the PMR head with the write element of FIG. 3C including a main-pole layer and a stepped-pole layer such that an interface between the main-pole layer and the stepped-pole layer is planarized to be substantially flat over a leading-edge taper of the stepped-pole layer, in accordance with an embodiment of the present invention.

FIG. 8A are cross-sectional elevation views of the write element of the PMR head illustrating initial stages in the wafer-level fabrication process of top portions of the write element of FIG. 3C including the fabrication of a non-magnetic taper-forming layer with a taper-forming portion for forming a leading-edge taper in the stepped-pole layer, in accordance with an embodiment of the present invention.

FIG. 8B are cross-sectional elevation views of the write element of the PMR head illustrating intermediate stages in the wafer-level fabrication process of top portions of the write element of FIG. 3C including the fabrication of the stepped-pole layer and the leading-edge taper in the stepped-pole layer, in accordance with an embodiment of the present invention.

FIG. 8C are cross-sectional elevation views of the write element of the PMR head illustrating final stages in the wafer-level fabrication process of top portions of the write element of FIG. 3C including the fabrication of the main-pole layer and an interface between the main-pole layer and the stepped-pole layer that is substantially flat over a leading-edge taper of the stepped-pole layer, in accordance with an embodiment of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of embodiments of the present invention. However, it should be noted that embodiments of the present invention may be practiced without these specific details. In other instances, well known methods, procedures, and components have not been described in detail as not to unnecessarily obscure embodiments of the present invention.

Physical Description of Embodiments of the Present Invention for a Perpendicular-Magnetic-Recording Head with a Leading-Edge Taper of a Planarized Stepped-Pole Layer Having Greater Recess Distance than a Flare Point of a Main-Pole Layer

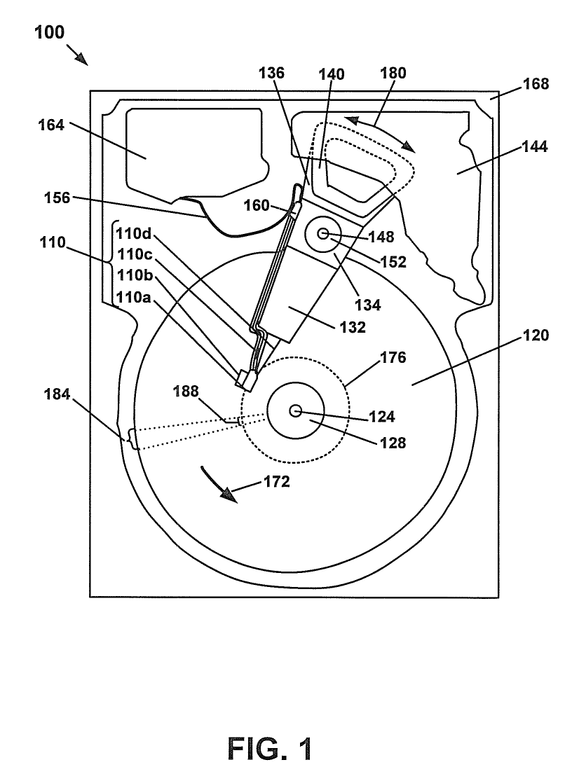

With reference to FIG. 1, in accordance with an embodiment of the present invention, a plan view of a HDD 100 is shown. FIG. 1 illustrates the functional arrangement of components of the HDD including a slider 110b including a perpendicular-magnetic-recording (PMR) head 110a with leading-edge taper of a planarized stepped-pole layer having greater recess distance than a flare point of a main-pole layer. The HDD 100 includes at least one HGA 110 including the PMR head 110a, a lead suspension 110c attached to the PMR head 110a, and a load beam 110d attached to the slider 110b, which includes the PMR head 110a at a distal end of the slider 110b; the slider 110b is attached at the distal end of the load beam 110d to a gimbal portion of the load beam 110d. The HDD 100 also includes at least one perpendicular-magnetic-recording (PMR) disk 120 rotatably mounted on a spindle 124 and a drive motor (not shown) attached to the spindle 124 for rotating the PMR disk 120. The PMR head 110a includes a write element, a so-called writer, and a read element, a so-called reader, for respectively writing and reading information stored on the PMR disk 120 of the HDD 100. The PMR disk 120 or a plurality (not shown) of PMR disks may be affixed to the spindle 124 with a disk clamp 128. The HDD 100 further includes an arm 132 attached to the HGA 110, a carriage 134, a voice-coil motor (VCM) that includes an armature 136 including a voice coil 140 attached to the carriage 134; and a stator 144 including a voice-coil magnet (not shown); the armature 136 of the VCM is attached to the carriage 134 and is configured to move the arm 132 and the HGA 110 to access portions of the PMR disk 120 being mounted on a pivot-shaft 148 with an interposed pivot-bearing assembly 152.

With further reference to FIG. 1, in accordance with an embodiment of the present invention, electrical signals, for example, current to the voice coil 140 of the VCM, write signal to and read signal from the PMR head 110a, are provided by a flexible cable 156. Interconnection between the flexible cable 156 and the PMR head 110a may be provided by an arm-electronics (AE) module 160, which may have an on-board pre-amplifier for the read signal, as well as other read-channel and write-channel electronic components. The flexible cable 156 is coupled to an electrical-connector block 164, which provides electrical communication through electrical feedthroughs (not shown) provided by an HDD housing 168. The HDD housing 168, also referred to as a casting, depending upon whether the HDD housing is cast, in conjunction with an HDD cover (not shown) provides a sealed, protective enclosure for the information storage components of the HDD 100.

With further reference to FIG. 1, in accordance with an embodiment of the present invention, other electronic components (not shown), including a disk controller and servo electronics including a digital-signal processor (DSP), provide electrical signals to the drive motor, the voice coil 140 of the VCM and the PMR head 110a of the HGA 110. The electrical signal provided to the drive motor enables the drive motor to spin providing a torque to the spindle 124 which is in turn transmitted to the PMR disk 120 that is affixed to the spindle 124 by the disk clamp 128; as a result, the PMR disk 120 spins in a direction 172. The spinning PMR disk 120 creates a cushion of air that acts as an air-bearing on which the air-bearing surface (ABS) of the slider 110b rides so that the slider 110b flies above the surface of the PMR disk 120 without making contact with a thin magnetic-recording medium of the PMR disk 120 in which information is recorded. The electrical signal provided to the voice coil 140 of the VCM enables the PMR head 110a of the HGA 110 to access a track 176 on which information is recorded. Thus, the armature 136 of the VCM swings through an arc 180 which enables the HGA 110 attached to the armature 136 by the arm 132 to access various tracks on the PMR disk 120. Information is stored on the PMR disk 120 in a plurality of concentric tracks (not shown) arranged in sectors on the PMR disk 120, for example, sector 184. Correspondingly, each track is composed of a plurality of sectored track portions, for example, sectored track portion 188. Each sectored track portion 188 is composed of recorded data and a header containing a servo-burst-signal pattern, for example, an ABCD-servo-burst-signal pattern, information that identifies the track 176, and error correction code information. In accessing the track 176, the read element of the PMR head 110a of the HGA 110 reads the servo-burst-signal pattern which provides a position-error-signal (PES) to the servo electronics, which controls the electrical signal provided to the voice coil 140 of the VCM, enabling the PMR head 110a to follow the track 176. Upon finding the track 176 and identifying a particular sectored track portion 188, the PMR head 110a either reads data from the track 176 or writes data to the track 176 depending on instructions received by the disk controller from an external agent, for example, a microprocessor of a computer system.

Embodiments of the present invention also encompass HDD 100 that includes the HGA 110, the PMR disk 120 rotatably mounted on the spindle 124, the arm 132 attached to the HGA 110 including the slider 110b including the PMR head 110a with leading-edge taper of a planarized stepped-pole layer having greater recess distance than a flare point of the main-pole layer. Therefore, embodiments of the present invention incorporate within the environment of the HDD 100, without limitation, the subsequently described embodiments of the present invention for the slider 110b including the PMR head 110a with leading-edge taper of a planarized stepped-pole layer having greater recess distance than a flare point of the main-pole layer as further described in the following discussion. Similarly, embodiments of the present invention incorporate within the environment of the HGA 110, without limitation, the subsequently described embodiments of the present invention for the slider 110b including the PMR head 110a with leading-edge taper of a planarized stepped-pole layer having greater recess distance than a flare point of the main-pole layer as further described in the following discussion.

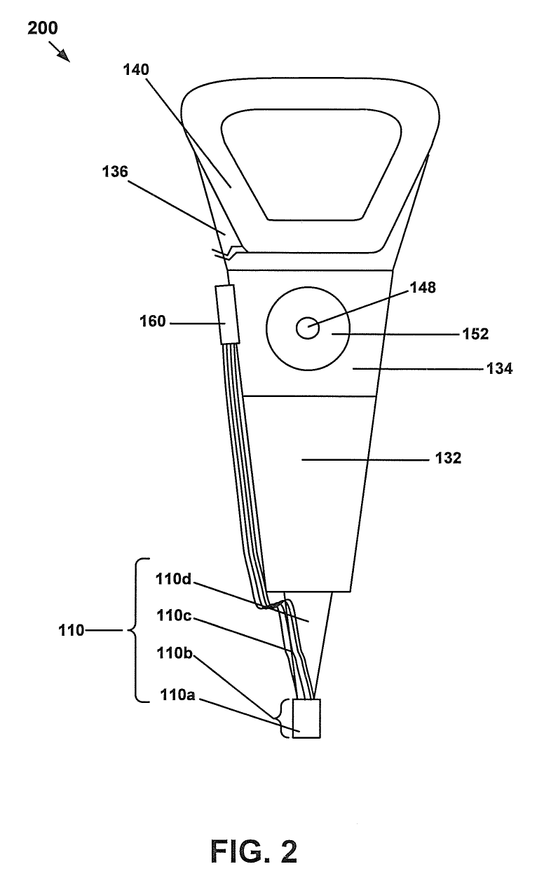

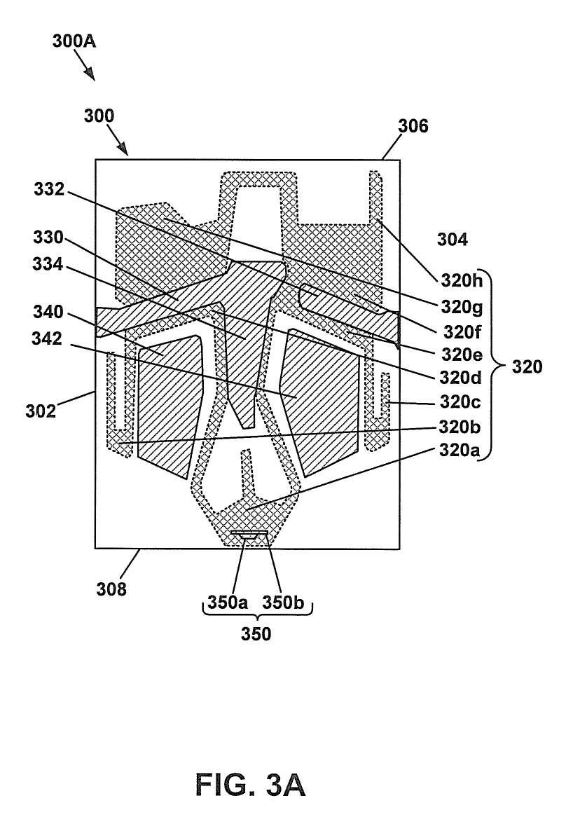

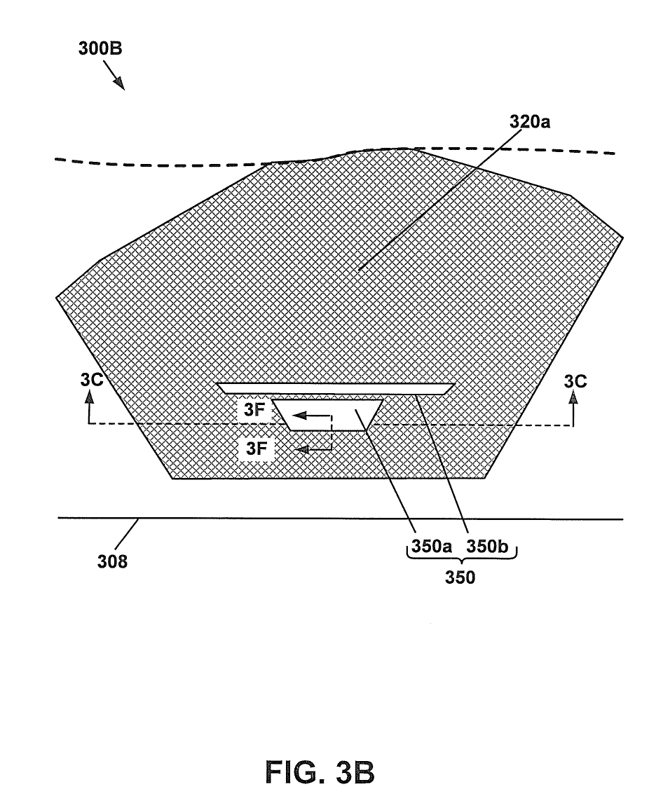

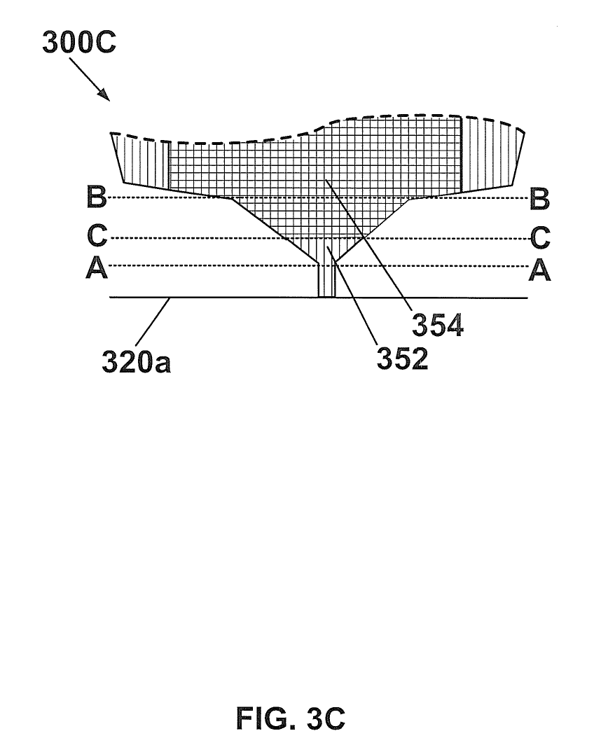

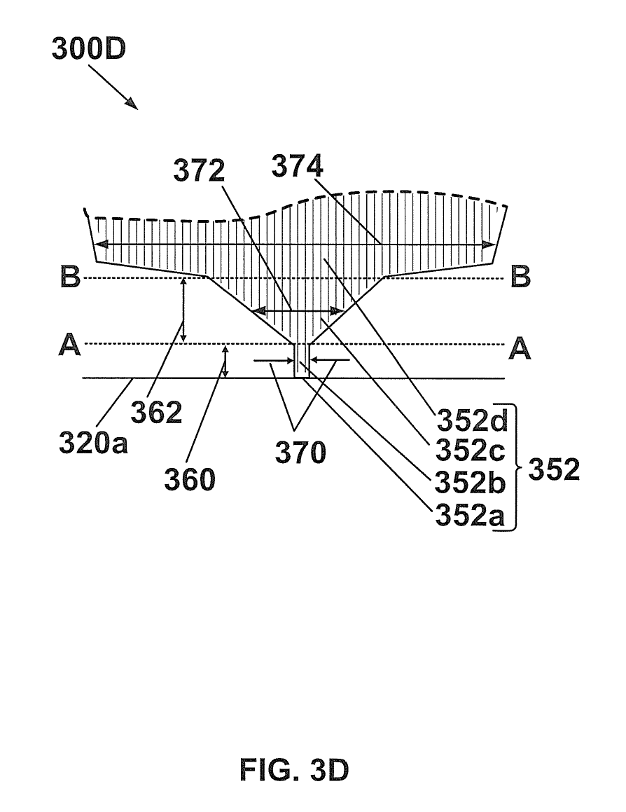

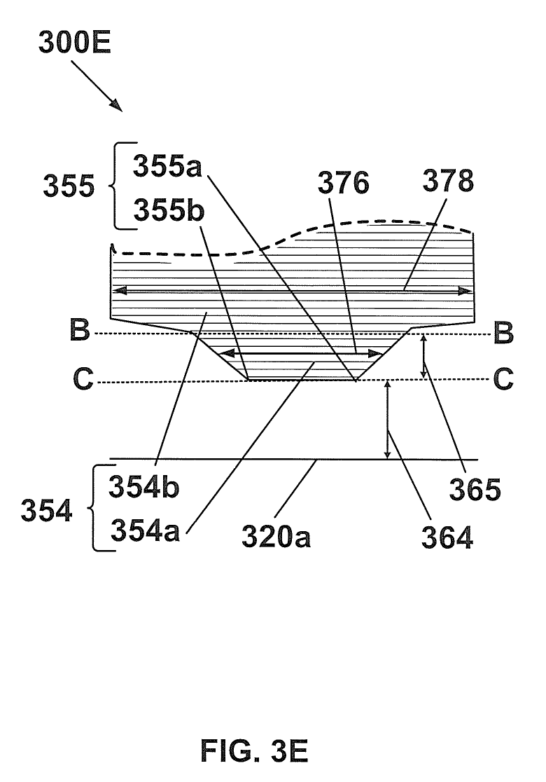

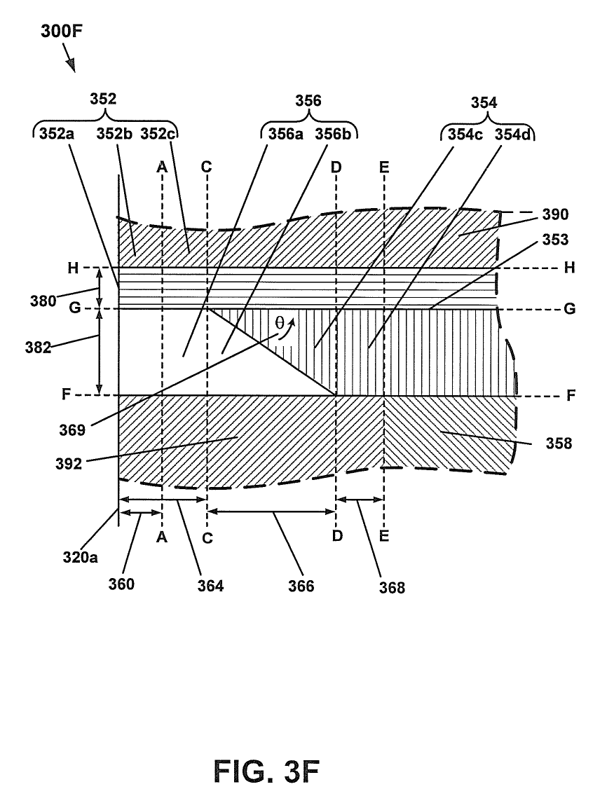

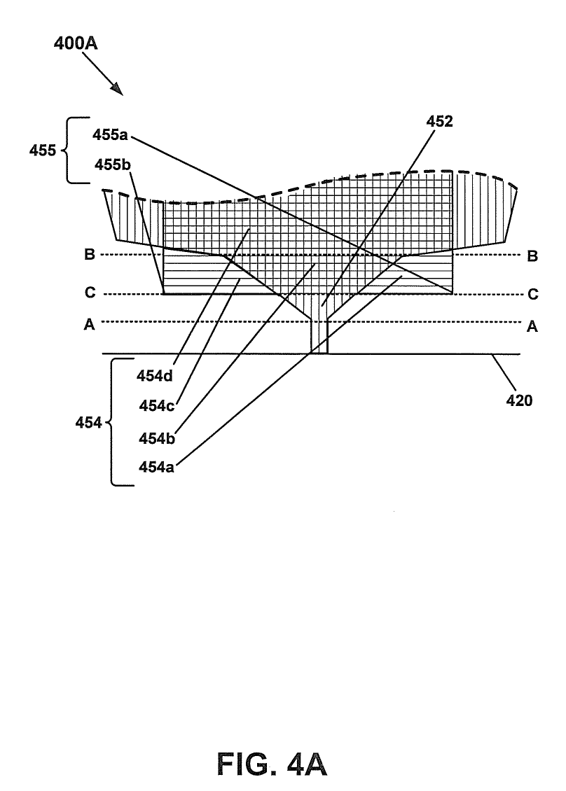

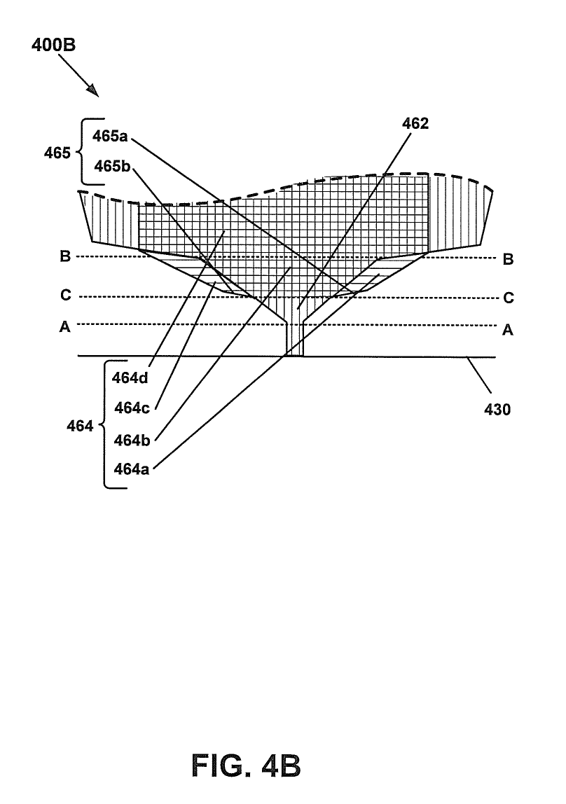

With reference now to FIG. 2, in accordance with an embodiment of the present invention, a plan view of a head-arm-assembly (HAA) including the HGA 110 is shown. FIG. 2 illustrates the functional arrangement of the HAA with respect to the HGA 110. The HAA includes the arm 132 and HGA 110 including the slider 110b including the PMR head 110a with leading-edge taper of a planarized stepped-pole layer having greater recess distance than a flare point of the main-pole layer. The HAA is attached at the arm 132 to the carriage 134. In the case of an HDD having multiple disks, or platters as disks are sometimes referred to in the art, the carriage 134 is called an “E-block,” or comb, because the carriage is arranged to carry a ganged array of arms that gives it the appearance of a comb. As shown in FIG. 2, the armature 136 of the VCM is attached to the carriage 134 and the voice coil 140 is attached to the armature 136. The AE 160 may be attached to the carriage 134 as shown. The carriage 134 is mounted on the pivot-shaft 148 with the interposed pivot-bearing assembly 152. The slider 110b including the PMR head 110a with leading-edge taper of a planarized stepped-pole layer having greater recess distance than a flare point of the main-pole layer is subsequently described in greater detail in FIGS. 3A-3F, 7 and 8A-8C. In addition, in FIGS. 4A and 4B, two alternative embodiments of the present invention are described.

With reference now to FIG. 3A, in accordance with an embodiment of the present invention, a plan view 300A of a slider 300 of the HGA 110 of FIG. 2 is shown. FIG. 3A shows the functional arrangement of components of the slider 300 including a PMR head 350. The slider 300 has the shape of a substantially rectangular parallelepiped; as used herein, with respect to a slider, the term “substantially rectangular” means that a slider has the shape of a rectangular box such that opposite sides of the box are about parallel to one another within manufacturing tolerances and specifications for fabricating the slider, without limitation, including any air-bearing surfaces, channels, etch pockets, overcoats or other structures present on a disk-facing slider-surface of a slider. The slider 300 includes six sides: a side configured to face an inside diameter (ID) of a PMR disk, for example, similar to the PMR disk 120, referred to herein as an ID side 302; a side configured to face an outside diameter of the PMR disk, an OD side 304; a side at a leading edge of the slider 300 configured to face into the direction 172 of motion of the PMR disk, a leading-edge (LE) side 306; a side at a trailing edge of the slider 300 configured to face away from the direction 172 of motion of the PMR disk, a TE side 308; a side configured to face the gimbal attachment at the end of the load beam 110d, a gimbal-facing side (not shown); and, a side configured to face the PMR disk, a disk-facing side. As used herein, the term of art “inside-diameter” refers to a structure closer to the ID side 302 than the OD side 304; the term of art “outside-diameter” refers to a structure closer to the OD side 304 than the ID side 302; the term of art “leading-edge” refers to a structure closer to the LE side 306 than the TE side 308; and, the term of art “trailing-edge” refers to a structure closer to the TE side 308 than the LE side 306. The disk-facing side includes a disk-facing slider-surface fabricated with a surface topography designed to facilitate flight of the slider 300 over the surface of the PMR disk, for example, similar to PMR disk 120.

With further reference to FIG. 3A, the disk-facing slider-surface includes the following portions: an air-bearing surface (ABS) 320; a deep, ID channel 330; a deep, OD channel 332; a deep, central channel 334; a deep, ID etch pocket 340; and, a deep, OD etch pocket 342. A positive-air-pressure portion of the slider 300 includes the ABS 320; the ABS 320 may further include: a TE center pad 320a; a TE ID rail 320b; a TE OD rail 320c; an ID, ABS-connecting portion 320d; an OD, ABS-connecting portion 320e; a LE OD pad 320f; a LE ID pad 320g; and, a LE OD rail 320h. A portion of the LE ID pad 320g may include a LE ID-rail portion; and, a portion of the LE OD pad 320f may include a LE OD-rail portion. The positive-air-pressure portion of the slider 300 generates a positive air pressure that creates a fluid-dynamic air-bearing that serves to levitate the slider 300 over a rotating PMR disk, for example, similar to the PMR disk 120, during operation of the HDD, for example, similar to HDD 100.

With further reference to FIG. 3A, a negative-air-pressure portion of the slider 300 may include the following portions: the deep, ID channel 330; the deep, OD channel 332; the deep, central channel 334; the deep, ID etch pocket 340; and, the deep, OD etch pocket 342. The negative-air-pressure portion generates a negative air pressure that serves to bring the slider 300 into close proximity of the surface of the rotating PMR disk during operation of the HDD. The balance of forces resulting from the positive air pressure generated by the positive-air-pressure portion, the negative air pressure generated by the negative-air-pressure portion, and the “gram load,” a term of art referring to the spring force exerted by the load beam 110d attached to the slider 110b, which may be identified with slider 300, cause the slider 300 to fly over the disk at a controlled distance, referred to by the term of art “fly height,” over the disk. This balance of forces serves to position PMR head 350, for example, similar to the PMR head 110a of FIGS. 1 and 2, in a communicating relationship with the PMR disk for writing data to and reading data from the PMR disk. To write data to and read data from the PMR disk, the fly height of the slider 300 is about 10 nanometers (nm), or less, at the location of the PMR head 350 at the TE side 308 of the slider 300.

With reference now to FIG. 3B, in accordance with an embodiment of the present invention, a magnified plan view 300B of the slider 300 of FIG. 3A at TE center pad 320a of ABS 320 is shown. FIG. 3B shows the functional arrangement of components of the PMR head 350 including a write element 350a and a read element 350b. As shown in FIG. 3B, the write element 350a is disposed closer to the TE side 308 than the read element 350b. Also, traces of two cutting planes indicated by dashed lines 3C-3C and 3F-3F are shown in FIG. 3B. The cutting plane indicated by dashed line 3C-3C lies parallel to the TE side 308, which corresponds to the top surface of the wafer used to manufacture the PMR head 350 of the slider 300 in a wafer-level fabrication process. The cutting plane indicated by dashed line 3F-3F lies perpendicular to both the TE side 308 and the cutting plane indicated by dashed line 3C-3C. The cutting planes indicated by dashed lines 3C-3C and 3F-3F are located at special positions in the PMR head 350 that facilitate the description of the structure and arrangement of the components of the PMR head 350, which are next described.

With reference now to FIG. 3C, in accordance with an embodiment of the present invention, a plan view 300C of the write element 350a of the PMR head 350 in the slider 300 of FIG. 3A as seen in the cutting plane 3C-3C of FIG. 3B is shown. FIG. 3C shows the disposition of a main-pole layer (MPL) 352, referred to by the term of art “P3 ,” on a stepped-pole layer (SPL) 354 in the write element 350a of the PMR bead 350. MPL 352 is shown with vertical hatch lines, and SPL 354 is shown with horizontal hatch lines. Also, the relative disposition of MPL 352 and SPL 354 are shown in FIG. 3C with respect to the TE center pad 320a of the ABS 320. Parallel to TE center pad 320a of the ABS 320 are traces of three planes parallel to ABS 320 that designate transitions in the shape of components of the write element 350a: trace of plane A-A demarcates the beginning of a flared portion of MPL 352, and is referred to by the term of art “flare point;” trace of plane B-B demarcates the end of the flared portion of MPL 352; and, trace of plane C-C demarcates the beginning of SPL 354. Thus, the cross-hatched lines indicate the portions of SPL 354 overlaid by MPL 352. In an embodiment of the present invention as shown in FIG. 3C, SPL 354 substantially replicates a shape of a flared portion of MPL 352 within a plane of SPL 354 under the flared portion of MPL 352, which reduces stray magnetic flux from SPL 354 below a level sufficient to cause adjacent track interference (ATI), which is further explained in the discussion of FIGS. 3D-3F. The shape and dimensions of MPL 352 and SPL 354 are further elaborated in FIGS. 3D and 3E, respectively, as are next described.

With reference now to FIG. 3D, in accordance with an embodiment of the present invention, a detailed plan view 300D of MPL 352 of the write element 350a of FIG. 3C is shown. FIG. 3D illustrates the component portions of MPL 352, which includes a pole tip 352a, a throat 352b, a flared portion 352c and a yoke portion 352d. The throat 352b extends from the trace of plane A-A to the TE center pad 320a of the ABS 320. The throat 352b terminates at the TE center pad 320a of the ABS 320 in the pole tip 352a. At the opposite end of the throat 352b, the trace of plane A-A demarcates the location of the flare point at the beginning of the flared portion 352c. The flared portion 352c extends from the flare point, demarcated by trace of plane A-A, to trace of plane B-B, which demarcates the beginning of the yoke portion 352d. The yoke portion 352d extends back from trace of plane B-B to connect to a back gap (not shown).

With further reference to FIG. 3D, in accordance with an embodiment of the present invention, associated with the throat 352b is a length dimension, referred to by the term of art “throat height” 360, which is defined in FIG. 3D by a first distance from the pole tip 352a of MPL 352 at the TE center pad 320a of the ABS 320 by which the flare point, demarcated by trace of plane A-A, is recessed below the TE center pad 320a of the ABS 320. Thus, the throat height 360 may be regarded as a recess distance for the flare point below the ABS 320. Also, associated with the throat 352b is a width dimension, which may be called a “throat width” 370. The throat 352b and the pole tip 352a may have a trapezoidal profile, without limitation thereto, when viewed perpendicular to the ABS 320, having a different width, for example, a narrower width, at the base of the profile than the width at the top of the profile. The throat width 370 may be called a “P3 W” dimension. As the view in FIG. 3D is onto the top of MPL 352, the “P3 W” dimension is defined as the P3 “width” dimension at the top of MPL 352 in the throat and at the top of pole-tip portions of MPL 352, for example, the width at the top of the profile, assuming without limitation a relatively constant profile of the throat 352b from the pole tip 352a to the flare point demarcated by trace of plane A-A. A corresponding “P3 B” dimension is defined as the P3 “bottom” dimension of MPL 352 in the throat and pole-tip portions of MPL 352, for example, the width at the bottom of the profile, assuming without limitation a relatively constant profile of the throat 352b from the pole tip 352a to the flare point demarcated by trace of plane A-A. As described above, the profiles of the throat 352b from the pole tip 352a to the flare point demarcated by trace of plane A-A are identified with the delineations at the periphery of cross-sections of the throat 352b perpendicular to the direction of the throat height 360 and parallel to ABS 320, as indicated by the TE center pad 320a of ABS 320 in FIG. 3D.

With further reference to FIG. 3D, in accordance with an embodiment of the present invention, associated with the flared portion 352c is a length dimension, which may be called a “flare length” 362. The flared portion 352c also has a width dimension, which may be called a “flare width” 372. However, the flare width 372 varies along the direction of the flare length 362 of the flared portion 352c. Associated with the yoke portion 352d is a width dimension, which may be called a “yoke width” 374. The yoke portion 352d also has a length dimension, which may be called a “yoke length” (not shown). The significance of these various dimensions is that the physical sizes of the pole tip 352a, the throat 352b, the flared portion 352c and the yoke portion 352d strongly influence the performance parameters of the write element 350a of the PMR head 350. For example, P3 W, which may be identified with the throat width 370, determines the track width written to a PMR disk. In addition, the length along with the effective cross-sectional area of each portion of P3 , MPL 352, determines the reluctance of that portion of MPL 352. The reluctance of MPL 352 determines the efficiency of the write element in transferring magnetic flux density to the PMR disk, which affects the signal-to-noise ratio (SNR) of recorded information on the PMR disk and in turn affects the soft error rate (SER) of information read back from the PMR disk by the read element 350b of the PMR head 350. Shorter lengths and greater cross-sections of the throat 352b, the flared portion 352c and the yoke portion 352d reduce the reluctance of the magnetic circuit conveying magnetic flux to the pole tip 352a and increase delivery of magnetic flux to the pole tip 352a of MPL 352. Thus, the function of the flared portion 352c is to bridge the transition from a wide low reluctance yoke portion 352d to a narrow throat 352b and pole tip 352a, whose dimensions are specified by the recording density targeted for a particular HDD design. In figurative language, the flared portion 352c serves to “funnel” the magnetic flux from the yoke portion 352d into the throat 352b and the pole tip 352a. Similar, functions apply to the portions of SPL 354, which are next described.

With reference now to FIG. 3E, in accordance with an embodiment of the present invention, a detailed plan view 300E of SPL 354 of the write element 350a of FIG. 3C is shown. FIG. 3E illustrates the component portions of SPL 354, which includes a flared portion 354a and a yoke portion 354b. The flared portion 354a extends from the leading-edge of the flared portion 354a, demarcated by trace of plane C-C, to trace of plane B-B, which demarcates the beginning of the yoke portion 354b. In embodiments of the present invention, the leading-edge of the flared portion 354a of SPL 354 includes a leading-edge taper (LET) 354c (see FIG. 3F). Associated with the LET 354c (see FIG. 3F) is a recess distance 364, which is defined in FIG. 3E by a second distance from the pole tip 352a of MPL 352 at the TE center pad 320a of the ABS 320 by which LET 354c (see FIG. 3F) is recessed below the TE center pad 320a of the ABS 320. Associated with the flared portion 354a is a length dimension, which may be called a “flare length” 365. The flared portion 354a also has a width dimension, which may be called a “flare width” 376. However, the flare width 376 varies along the direction of the flare length 365 of the flared portion 354a. Associated with the yoke portion 354b is a width dimension, which may be called a “yoke width” 378. The yoke portion 354b also has a length dimension, which may be called a “yoke length” (not shown).

With further reference to FIG. 3E, in accordance with an embodiment of the present invention, the physical sizes of the flared portion 354a and the yoke portion 354b similarly strongly influence the performance parameters of the write element 350a of the PMR head 350. The length along with the effective cross-sectional area of each portion of SPL 354 determines the reluctance of that portion of SPL 354. The reluctance of SPL 354 also affects the efficiency of the write element 350a in transferring magnetic flux density to the PMR disk, which affects the SNR of recorded information on the PMR disk and in turn affects the SER of information read back from the PMR disk by the read element 350b of the PMR head 350. Shorter lengths and greater cross-sections of the flared portion 354a and the yoke portion 354b further reduce the reluctance of the magnetic circuit conveying magnetic flux to the pole tip 352a and increase delivery of magnetic flux to the pole tip 352a of MPL 352. Thus, the function of the flared portion 354a is to bridge the transition from a wide low reluctance yoke portion 354b to a narrow throat 352b and pole tip 352a, whose dimensions are specified by the recording density targeted for a particular HDD design. By magnetically coupling SPL 354 with MPL 352 across an interface between MPL 352 and SPL 354, the flared portion 354a of SPL 354 figuratively “funnels” the magnetic flux from the yoke portion 354b into the flared portion 352c of MPL 352 through the LET 354c (see FIG. 3F) where the flared portion 352c of MPL 352 can further “funnel” the magnetic flux into the throat 352b and onto the pole tip 352a, which is later discussed in greater detail in the description of FIG. 3F.

With further reference to FIG. 3E, in accordance with an embodiment of the present invention, it would seem desirable to bring the leading-edge of the flared portion 354a of SPL 354, demarcated by trace of plane C-C, as close as possible to the flare point of MPL 352, demarcated by trace of plane A-A. However, the flared portion 354a of SPL 354 has corners 355 including an ID corner 355a and an OD corner 355b, which generate high edge fields as is known from Magnetostatic Theory in the Theory of Electromagnetism. These edge fields create regions for the leakage of magnetic flux from the flared portion 354a of SPL 354 at corners 355 which if brought sufficiently close to the PMR disk could write spurious fields to the PMR disk with a width on the order of the flare width 376 at the leading-edge of the flared portion 354a of SPL 354 greater than the track width associated with the throat width 370, P3 W, which determines the track width of the track written to the PMR disk. The writing of fields outside the track width determined by P3 W of the pole tip 352a of MPL 352 gives rise to the deleterious phenomenon of ATI. Therefore, it is desirable to recess the leading-edge of the flared portion 354a of SPL 354 with recess distance 364 from the ABS 320 greater than the throat height 360 of the flare point of the flared portion 352c of MPL 352, so that LET 354c (see FIG. 3F) of SPL 354 has greater recess distance than the flare point of MPL 352. In another embodiment of the present invention, the deleterious phenomenon of ATI is further ameliorated by mitigating the leakage magnetic flux emanating from the corners 355 by providing a high magnetic permeability path for the magnetic flux to follow. Such a high magnetic permeability path is provided by arranging SPL 354 to substantially replicate the shape of the flared portion 352c of MPL 352 within the plane of SPL 354 under the flared portion 352c of MPL 352 to reduce stray magnetic flux from SPL 354 below a level sufficient to cause ATI, as described above and shown in FIG. 3C.

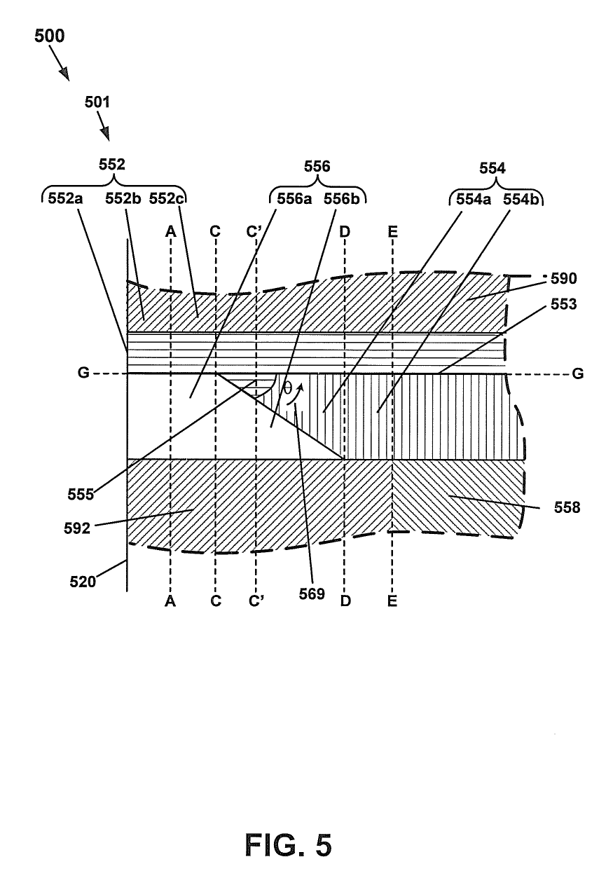

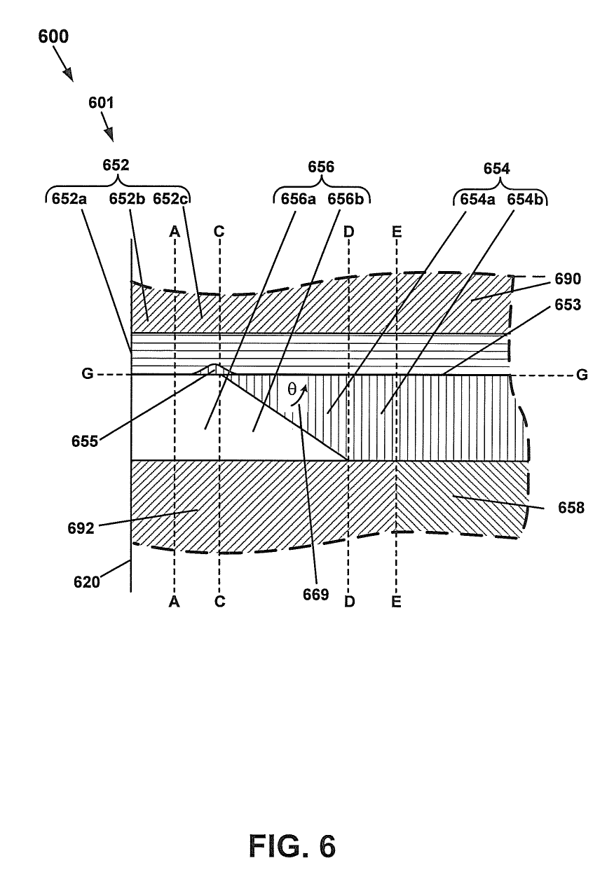

With reference now to FIG. 3F, in accordance with embodiments of the present invention, a cross-sectional elevation view 300F of the write element 350a of FIG. 3C of the PMR head 350 is shown as seen in the cutting plane 3F-3F in the slider 300 of FIG. 3B. FIG. 3F shows the functional arrangement of components of the write element 350a including MPL 352, a shaping layer (SL) 358, a taper forming layer (TFL) 356 and SPL 354 with LET 354c. MPL 352 is shown with horizontal hatch lines to indicate that MPL 352 may be a laminate formed of a multilayer structure including a plurality of repeated periods of cobalt-iron-on-alumina bilayers; alternatively, the multilayer structure may include a plurality of repeated periods of nickel-iron-on-alumina bilayers, a plurality of repeated periods of cobalt-iron-on-nickel-iron-on-alumina trilayers, or a plurality of repeated periods of cobalt-nickel-iron-on-alumina bilayers in which the amount of nickel is greater than the amount of cobalt. Other magnetic components of the write element 350a, Such as SPL 354 and SL 358, may be composed of permalloy, having the composition: 80 atomic percent nickel and 20 atomic percent iron. In accordance with embodiments of the present invention, FIG. 3F shows PMR head 350 with LET 354c of a planarized SPL 354 that has greater recess distance 364, demarcated by trace of plane C-C, than a flare point of MPL 352, demarcated by trace of plane A-A. The PMR head 350 includes the write element 350a. The write element 350a further includes MPL 352 which has flare point, demarcated by trace of plane A-A. The flare point is recessed a first distance, which may be identified with throat height 360, from pole tip 352a of MPL 352 at ABS 320 below ABS 320, corresponding to TE center pad 320a. The write element 350a also includes SPL 354 magnetically coupled with MPL 352 across an interface 353 between MPL 352 and SPL 354. SPL 354 has LET 354c such that LET 354c is recessed a second distance, which may be identified with recess distance 364, from the pole tip 352a of MPL 352 at ABS 320 below ABS 320, corresponding to TE center pad 320a. The second distance of the LET 354c, which may be identified with recess distance 364, is greater than the first distance of the flare point, which may be identified with throat height 360. Thus, stray magnetic flux, leakage magnetic flux, from SPL 354 may be reduced below a level sufficient to cause ATI. The interface 353 between MPL 352 and SPL 354, which corresponds to the trace of plane G-G, is planarized to be substantially flat over LET 354c, the importance of which is later discussed in the description of FIGS. 5 and 6. As used herein, the term “substantially flat” means about as flat as can reasonably be produced with known thin-film planarization techniques, such as chemical-mechanical polishing, reactive-ion milling, reactive-ion etching, or ion milling, in a manufacturing process. SPL 354 increases delivery of magnetic flux to the pole tip 352a of MPL 352. The write element 350a of the PMR head 350 may also include other component parts, known from the art of fabricating PMR heads, which are not shown in FIG. 3F, so as not to obscure the novelty of embodiments of the present invention; these other component parts include: a return pole layer, referred to by the term of art “P1,” a back gap, a coil layer, a trailing-edge shield, including wrap-around shield variations of the trailing-edge shield, and various sputtered alumina fill layers.

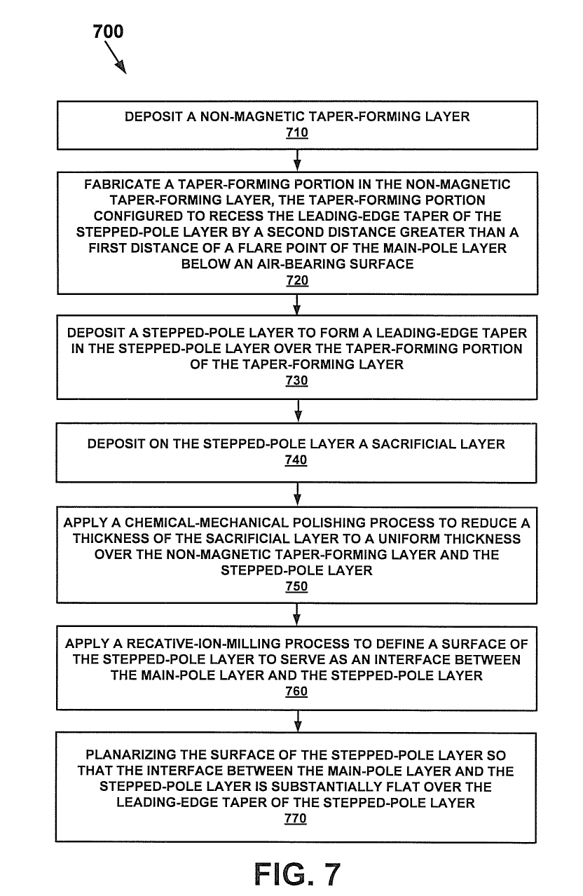

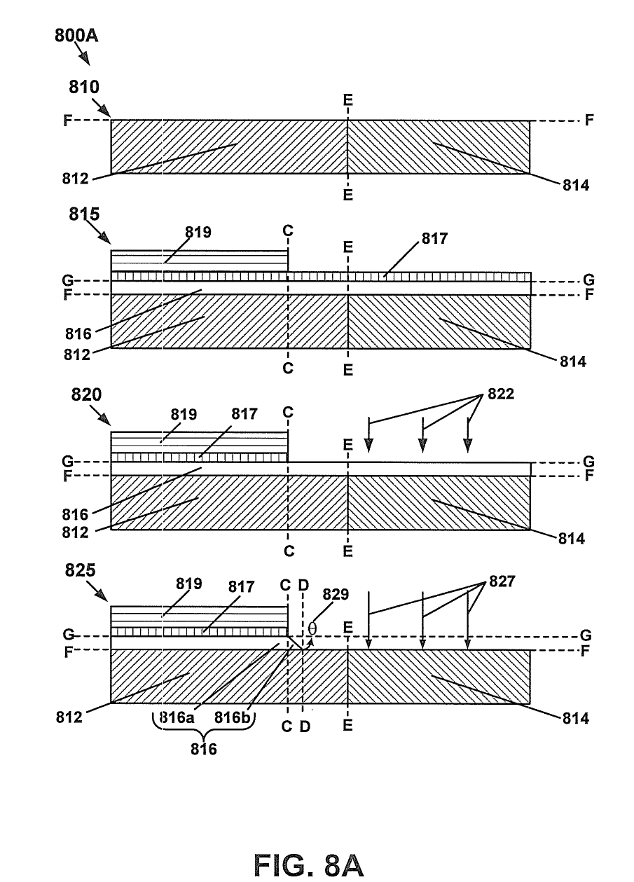

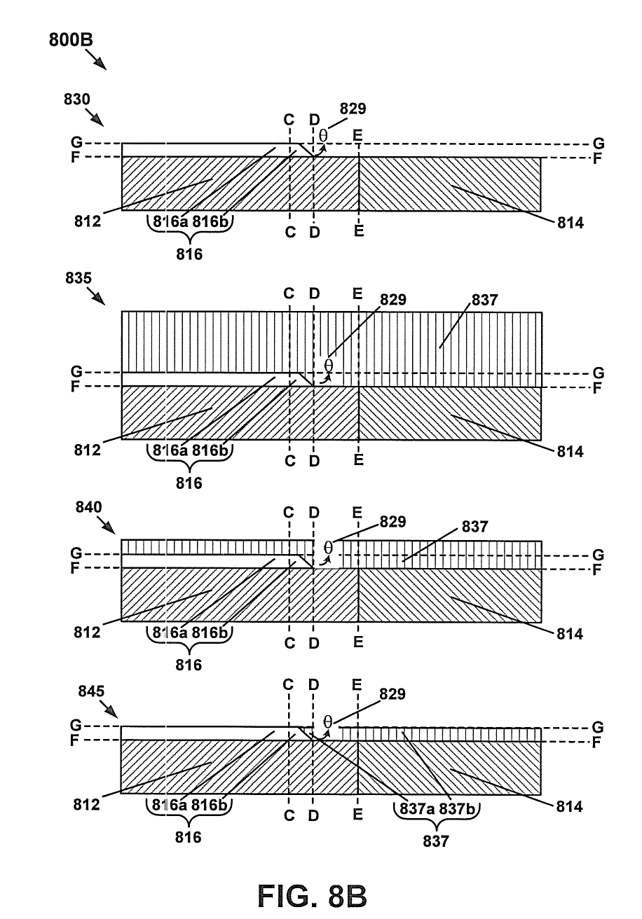

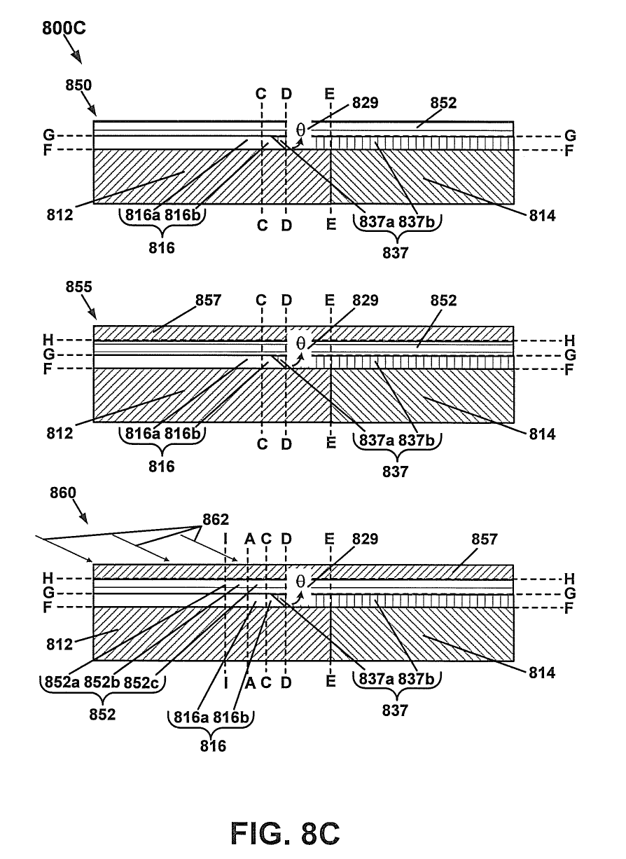

With further reference to FIG. 3F, in accordance with embodiments of the present invention, SL 358, referred to by the term of art “P2,” and sputtered alumina fill layer 392 form a substrate upon which TFL 356 and SPL 354 are formed. TFL 356 and SPL 354 are fabricated on the top surfaces of SL 358 and sputtered alumina fill layer 392, demarcated by trace of plane F-F, as is subsequently discussed in the description of FIGS. 7 and 8A-8C. TFL 356 includes a non-taper-forming portion 356a and a taper-forming portion 356b; TFL 356 is composed of a non-magnetic material to facilitate the funneling effect on magnetic flux delivered to the pole tip 352a. The non-taper-forming portion 356a of TFL 356 extends from the TE center pad 320a of ABS 320 to the tip of LET 354c, demarcated by trace of plane C-C. The taper-forming portion 356b of TFL 356 extends from the tip of LET 354c, demarcated by trace of plane C-C, to the back of LET 354c, demarcated by trace of plane D-D, and is bounded on the bottom by the top surface of sputtered alumina fill layer 392, demarcated by trace of plane F-F, and, on the top by a sloped boundary. The taper-forming portion 356b of TFL 356 provides a template upon which LET 354c is formed. In one embodiment of the present invention, the taper-forming portion 356b of TFL 356 may have the shape of a ramp with a run length, rl, 366 and a rise height, rh, 382, which also corresponds to the thickness of TFL 356 and SPL 354. The slope of the ramp of taper-forming portion 356b is given by: rh/rl, which determines the taper angle, θ, 369 through the formula: θ=arctan (rh/rl). The greater the taper angle, θ, 369 is the more efficient is delivery of magnetic flux to the throat 352b of MPL 352, which in turn increases the write field, for example, the magnetic flux density, delivered by the pole tip 352a to the PMR disk. SPL 354 includes LET 354c and a non-leading-edge-taper portion 354d. In embodiments of the present invention, portions of LET 354c may also include, without limitation thereto, portions of flared portion 354a and yoke portion 354b depending on the location of the trace of plane B-B, which demarcates the end of the flared portion 354a, with respect to the traces of cutting planes D-D and C-C. Similarly, portions of non-leading-edge-taper portion 354d may also include, without limitation thereto, portions of flared portion 354a and yoke portion 354b depending on the location of the trace of plane B-B with respect to the trace of plane D-D. Also, in embodiments of the present invention, LET 354c may be separated from, without limitation thereto, the leading-edge of SL 358, demarcated by trace of plane E-E, by a separation distance 368. In addition, SL 358 is magnetically coupled with SPL 354 across the interface between SL 358 and SPL 354 that coincides with the portion of the trace of plane F-F between SL 358 and SPL 354, which increases the delivery of magnetic flux to SPL 354 for delivery to the pole tip 352a by way of the throat 352b of MPL 352.

With further reference to FIG. 3F, in accordance with embodiments of the present invention, SPL 354 and TFL 356 form a substrate upon which MPL 352 is formed. MPL 352 is fabricated on the top surfaces of SPL 354 and TFL 356, demarcated by trace of plane G-G, as is subsequently discussed in the description of FIGS. 7 and 8A-8C. As shown in FIG. 3F, MPL 352 includes pole tip 352a, throat 352b and flared portion 352c. Yoke portion 352d of MPL 352 is not shown in FIG. 3F, because the location of yoke portion 352d depends on whether the location of the trace of plane B-B lies between the traces of cutting planes C-C and D-D or to the right of the trace of plane D-D. The trace of plane G-G coincides with the interface 353 between MPL 352 and SPL 354, as well as between MPL 352 and TFL 356. MPL 352 is magnetically coupled with SPL 354 across interface 353. The thickness of MPL 352, which may be identified with the term of art “P3 thickness” (P3 T) 380, is determined by the distance separating bottom of MPL 352 defined by trace of plane G-G and the top of MPL 352 defined by trace of plane H-H. P3 T along with the effective width of P3 determine the magnetic field, or magnetic flux density, delivered by the pole tip 352a of MPL 352 to the PMR disk, as the magnetic flux density is given by the magnetic flux emanating from the pole tip 352a divided by it cross-sectional area. In an embodiment of the present invention, the effective width of P3 may be determined, without limitation thereto, by the throat width 370, P3 W, and P3 B dimensions of the pole tip 352a of MPL 352 with a trapezoidal profile at the ABS 320. Thus, the magnetic flux density may be increased by increasing the magnetic flux delivered to the pole tip 352a by reducing the reluctances of various portions of write element 350a conveying magnetic flux to the pole tip 352a, as have been described herein, and by reducing the cross-sectional area of the pole tip 352a by reducing P3 T 380 and the effective width of the pole tip 352a, which in the case of pole tip 352a with a trapezoidal profile is determined by throat width 370, P3 W, and P3 B. An overcoating layer 390 that covers MPL 352 is also shown in FIG. 3F. In one embodiment of the present invention, overcoating layer 390 may include, without limitation thereto, a sputtered alumina layer. However, overcoating layer 390 may also include portions of the trailing-edge shield, including wrap-around shield variations of the trailing-edge shield, mentioned above. Although the efficiency of the write element 350a of PMR head 350 has been described from the point of view of magnetic flux density delivered by the pole tip 352a, the resolution of transitions between bits written by the magnetic flux density onto the PMR disk, which affects the areal density (AD) of recorded information, depends on the magnetic flux density gradient at the TE, or top, of the pole tip 352a, which is strongly affected by a trailing-edge shield, including wrap-around shield variations of the trailing-edge shield, which is beyond the scope of this discussion.

With reference now to FIG. 4A, in accordance with an alternative embodiment of the present invention, a plan view 400A of a write element of a PMR head having a flare-extension portion with a substantially squared corner in a plane of SPL 454 and a side oriented perpendicular to the ABS 420, a so-called “vertical” flare-extension portion, is shown, which is otherwise similar to write element 350a of PMR head 350 of FIGS. 3A and 3B. FIG. 4A shows the disposition of MPL 452 on SPL 454, similar to the disposition and arrangement of MPL 352 on SPL 354 shown in FIG. 3C. MPL 452 is shown with vertical hatch lines, and SPL 454 is shown with horizontal hatch lines. Also, the relative disposition of MPL 452 and SPL 454 are shown in FIG. 4A with respect to an ABS 420. Parallel to the ABS 420 are traces of three planes parallel to ABS 420 that designate transitions in the shape of components of the write element: trace of plane A-A demarcates the beginning of a flared portion of MPL 452, or the flare point of MPL 452; trace of plane B-B demarcates the end of the flared portion of MPL 452; and, trace of plane C-C demarcates the beginning of SPL 454. Thus, the cross-hatched lines indicate the portions of SPL 454 overlaid by MPL 452. SPL 454 includes a flared portion 454b and a yoke portion 454d. The flared portion 454b of SPL 454 extends from the leading-edge of the flared portion 454b, demarcated by trace of plane C-C, to trace of plane B-B, which demarcates the beginning of the yoke portion 454d of SPL 454, and replicates a shape of the flared portion of MPL 452 within a plane of SPL 454 under the flared portion of MPL 452. Note that throughout the following discussions, the traces of planes identified by A-A, B-B, C-C, D-D, E-E, F-F, G-G and H-H are specific to the individual figures in which the traces appear, unless indicated to the contrary; however, the choice of the designations: A-A, B-B, C-C, D-D, E-E, F-F, G-G and H-H, is intended to convey a similarity in function and disposition of similarly designated traces of planes in other figures, although not identity with such similarly designated traces of planes.

With further reference to FIG. 4A, in accordance with an alternative embodiment of the present invention, the leading-edge of the flared portion 454b of SPL 454 includes a LET (not shown), similar to that described in FIG. 3F. SPL 454 further includes flare-extension portions 454a and 454c including an ID flare-extension portion 454a and an OD flare-extension portion 454c, which extend outwards from the sides of the flared portion 454b of SPL 454 towards the ID side and the OD side of the slider, respectively, for example, slider 300. The flare-extension portions of SPL 454 extend laterally in a direction parallel to ABS 420, in back of and parallel to the trace of plane C-C, of the PMR head within a plane of SPL 454 beyond a flared portion of MPL 452 to increase delivery of magnetic flux to the pole tip of MPL 452, similar to pole tip 352a of MPL 352 of FIGS. 3C, 3D and 3F. The flare-extension portions 454a and 454c may be selected from the group consisting of a flare-extension portion including a substantially squared corner and a side oriented perpendicular to the ABS 420, such as ID flare-extension-portion corner 455a and an OD flare-extension-portion corner 455b, in the plane of SPL 454. As used herein, the term “substantially square” with respect to the ID flare-extension-portion corner 455a and an OD flare-extension-portion corner 455b means that the interior angle at ID flare-extension-portion corner 455a and at OD flare-extension-portion corner 455b is, respectively, about 90 degrees. The flare-extension portions 454a and 454c extend backwards from the trace of plane C-C, demarcating the LET of SPL 454, to the front end of the yoke portion of MPL 452. Thus, the structure including flared portion 454b, flare-extension portions 454a and 454c of SPL 454 provide a minimal reluctance path for the delivery of magnetic flux by SPL 454 to MPL 452. The ID flare-extension-portion corner 455a and an OD flare-extension-portion corner 455b allow bringing the full width of the yoke portion 454d of SPL 454 right up to the trace of plane C-C, demarcating the LET of SPL 454. However, as mentioned earlier, sharp corners, such as ID flare-extension-portion corner 455a and OD flare-extension-portion corner 455b, may generate high edge fields, which depending on the recess distance of SPL 454, given by the distance between ABS 420 and the trace of plane C-C, can cause ATI. Embodiments of the present invention that diminish high edge fields that can cause ATI are next described.

With reference now to FIG. 4B, in accordance with embodiments of the present invention, a plan view 400B of a write element of a PMR head illustrating the disposition of a MPL 462 on a SPL 464 having a flare-extension portion with a chamfered corner in a plane of SPL 464 with a side oriented at a skewed angle to the ABS 430, a so-called “tapered” flare-extension portion, is shown, which is otherwise similar to write element 350a of PMR head 350 of FIGS. 3A and 3B. FIG. 4B shows the disposition of MPL 462 on SPL 464, similar to the disposition and arrangement of MPL 352 on SPL 354 shown in FIG. 3C. MPL 462 is shown with vertical hatch lines, and SPL 464 is shown with horizontal hatch lines. Also, the relative disposition of MPL 462 and SPL 464 are shown in FIG. 4B with respect to an ABS 430. Parallel to the ABS 430 are traces of three planes parallel to ABS 430 that designate transitions in the shape of components of the write element: trace of plane A-A demarcates the beginning of a flared portion of MPL 462, or the flare point of MPL 462; trace of plane B-B demarcates the end of the flared portion of MPL 462; and, trace of plane C-C demarcates the beginning of SPL 464. Thus, the cross-hatched lines indicate the portions of SPL 464 overlaid by MPL 462. SPL 464 includes a flared portion 464b and a yoke portion 464d. The flared portion 464b of SPL 464 extends from the leading-edge of the flared portion 464b, demarcated by trace of plane C-C, to trace of plane B-B, which demarcates the beginning of the yoke portion 464d of SPL 464, and replicates a shape of the flared portion of MPL 462 within a plane of SPL 464 under the flared portion of MPL 462.

With further reference to FIG. 4B, in accordance with an alternative embodiment of the present invention, the leading-edge of the flared portion 464b of SPL 464 includes a LET (not shown), similar to that described in FIG. 3F. SPL 464 further includes flare-extension portions 464a and 464c including an ID flare-extension portion 464a and an OD flare-extension portion 464c, which extend outwards from the sides of the flared portion 464b of SPL 464 towards the ID side and the OD side, respectively, of the slider, for example slider 300, but do not extend to the full width of the yoke portion 464d of SPL 464. The flare-extension portions of SPL 464 extend laterally in a direction parallel to ABS 430, in back of the trace of plane C-C, of the PMR head within a plane of SPL 464 beyond a flared portion of MPL 462 to increase delivery of magnetic flux to the pole tip of MPL 462, similar to pole tip 352a of MPL 352 of FIGS. 3C, 3D and 3F. The flare-extension portions 464a and 464c may be selected from the group consisting of a flare-extension portion including a chamfered corner with a side oriented at a skewed angle to ABS 430, such as ID flare-extension-portion corner 465a and an OD flare-extension-portion corner 465b, in the plane of SPL 464. The flare-extension portions 464a and 464c extend backwards from leading-edges recessed behind the trace of plane C-C towards the front end of the yoke portion of MPL 462. Thus, the structure including flared portion 464b, flare-extension portions 464a and 464c of SPL 464 provide a lowered reluctance path for the delivery of magnetic flux by SPL 464 to MPL 462, but not as low as the structure of FIG. 4A discussed above. The ID flare-extension-portion corner 465a and the OD flare-extension-portion corner 465b allow a wider portion of the SPL 464 greater than the width of the flared portion 464b, but not as great as the width of the yoke portion 464d of SPL 464, to facilitate delivery of magnetic flux forward towards the LET of SPL 464. The chamfered corners, such as ID flare-extension-portion corner 465a and OD flare-extension-portion corner 465b, produce lessened edge fields that might cause ATI, which also depends on the recess distance of SPL 464, given by the distance between ABS 430 and the leading-edges of the flared portion 464b and flare-extension portions 464a and 464c of SPL 464. Therefore, the design of SPL 464 shown in FIG. 4B represents a compromise between the high flux transfer efficiency design of FIG. 4A and the low ATI design of FIG. 3C. Thus, flare-extension portions may be selected from the group consisting of a flare-extension portion having a substantially squared corner in a plane of the SPL and a side oriented perpendicular to the ABS, a so-called “vertical” flare-extension portion, and a flare-extension portion having a chamfered corner in a plane of the SPL with a side oriented at a skewed angle to the ABS, a so-called “tapered” flare-extension portion, depending on the design requirements of a write element of a PMR head for a particular HDD design.

With reference now to FIG. 5, in order to more fully demonstrate the utility of embodiments of the present invention, a cross-sectional elevation view 500 of a write element 501 of a PMR head having a material-loss artifact 555 in SPL 554 is shown, which is otherwise similar to write element 350a of PMR head 350 of FIGS. 3A-3F. FIG. 5 shows the functional arrangement of components of the write element 501 including MPL 552, SL 558, TFL 556 and SPL 554 with LET 554a, with respect to the material-loss artifact 555 in the SPL 554. FIG. 5 shows the write element 501 of the PMR head with LET 554a of a non-planarized SPL 554 that has greater recess distance, given by the separation between ABS 520 and plane C′-C′, than a recess distance of a flare point of MPL 552, given by the separation between ABS 520 and plane A-A. The PMR head of FIG. 5 includes write element 501. The write element 501 further includes MPL 552 which has the flare point, demarcated by trace of plane A-A. The flare point is recessed a first distance, similar to throat height 360 of FIGS. 3D and 3F, from a pole tip 552a of MPL 552 at an ABS 520 below the ABS 520. The write element 501 also includes SPL 554 magnetically coupled with MPL 552 across an interface 553 between MPL 552 and SPL 554. SPL 554 has LET 554a such that LET 554a is recessed a second distance, similar to recess distance 364 of FIGS. 3E and 3F, from the pole tip 552a of MPL 552 at ABS 520 below ABS 520. The second distance of the LET 554a, similar to recess distance 364 of FIGS. 3E and 3F, given by the separation between ABS 520 and plane C′-C′, is greater than the first distance of the flare point, given by the separation between ABS 520 and plane A-A. However, the second distance of LET 554a is greater than the second distance of LET 554a would be in the absence of the material-loss artifact 555, given by the separation between ABS 520 and plane C-C. Nevertheless, stray magnetic flux, leakage magnetic flux, from SPL 554 may be reduced below a level sufficient to cause ATI. However, the interface 553 between MPL 552 and SPL 554 is non-planar, as LET 554a at the interface 553 between MPL 552 and SPL 554 includes material-loss artifact 555 in SPL 554. The material-loss artifact 555 that intrudes into SPL 554 at LET 554a may decrease delivery of magnetic flux to the pole tip 552a of MPL 552, because the tip of LET 554a, demarcated by trace of plane C′-C′, is offset further back from ABS 520 than the tip of LET 554a in the absence of the material-loss artifact 555, demarcated by trace of plane C-C. The material-loss artifact 555 may arise in the fabrication of the structures of write element 501, when certain procedures such as chemical-mechanical polishing (CMP) are directly applied to create the interface 553. CMP can result in selective removal of material at the junction between TFL 556 and LET 554a of SPL 554. Embodiments of the present invention, later discussed in the description of FIGS. 7 and 8A-8C, employ procedures to produce a write element of a PMR head, similar to write element 350a of PMR head 350 of FIGS. 3A-3F, such that a LET at the interface between a MPL and a SPL is without a material-loss artifact in the SPL, similar to the manner in which LET 354c at the interface 353 between MPL 352 and SPL 354 is without a material-loss artifact in SPL 354, as shown in FIG. 3F.

With further reference to FIG. 5, in order to more fully demonstrate the utility of embodiments of the present invention, SL 558 and sputtered alumina fill layer 592 form a substrate upon which TFL 556 and SPL 554 are formed. TFL 556 and SPL 554 are fabricated on the top surfaces of SL 558 and sputtered alumina fill layer 592. TFL 556 includes a non-taper-forming portion 556a and a taper-forming portion 556b; TFL 556 is composed of a non-magnetic material to facilitate the funneling effect on magnetic flux delivered to the pole tip 552a. The non-taper-forming portion 556a of TFL 556 extends from ABS 520 to the trace of plane C-C. The taper-forming portion 556b of TFL 556 extends from the trace of plane C-C, to the back of LET 554a, demarcated by trace of plane D-D. The taper-forming portion 556b of TFL 556 provides a template upon which LET 554a is formed. The taper-forming portion 556b of TFL 556 may have the shape of a ramp with a run length, rl, and a rise height, rh, which also corresponds to the thickness of TFL 556 and SPL 554. The slope of the ramp of taper-forming portion 556b is given by: rh/rl, which determines the taper angle, θ, 569. However, material-loss artifact 555 interferes with formation of LET 554a having reproducible and well-formed contour in the vicinity of tip of LET 554a, which may have a deleterious effect on delivery of magnetic flux from SPL 554 to MPL 552 in this critical region.

With further reference to FIG. 5, in order to more fully demonstrate the utility of embodiments of the present invention, SPL 554 includes LET 554a and a non-leading-edge-taper portion 554b. SL 558 may be magnetically coupled with SPL 554 across the interface between SL 558 and SPL 554. SPL 554 and TFL 556 form a substrate upon which MPL 552 is formed. MPL 552 is fabricated on the top surfaces of SPL 554 and TFL 556, demarcated by trace of plane G-G. As shown in FIG. 5, MPL 552 includes pole tip 552a, throat 552b and flared portion 552c. MPL 552 is magnetically coupled with SPL 554 across interface 553. However, material-loss artifact 555 interferes with delivery of magnetic flux from SPL 554 to MPL 552 across the critical interface 553. Also shown in FIG. 5, is overcoating layer 590 that covers MPL 552. Overcoating layer 590 may include, without limitation thereto, a sputtered alumina layer.

With reference now to FIG. 6, in order to more fully demonstrate the utility of embodiments of the present invention, a cross-sectional elevation view 600 of a write element 601 of a PMR head having a material-excess artifact 655 intruding into MPL 652 is shown, which is otherwise similar to write element 350a of PMR head 350 of FIGS. 3A-3F. FIG. 6 shows the functional arrangement of components of the write element 601 including MPL 652, SL 658, TFL 656 and SPL 654 with LET 654a, with respect to the material-excess artifact 655 in the MPL 652. FIG. 6 shows the write element 601 of the PMR head with LET 654a of a non-planarized SPL 654 that has greater recess distance, demarcated by trace of plane C-C, than a flare point of MPL 652, demarcated by trace of plane A-A. The PMR head of FIG. 6 includes write element 601. The write element 601 further includes MPL 652 which has flare point, demarcated by trace of plane A-A. The flare point is recessed a first distance, similar to throat height 360 of FIGS. 3D and 3F, from a pole tip 652a of MPL 652 at an ABS 620 below the ABS 620. The write element 601 also includes SPL 654 magnetically coupled with MPL 652 across an interface 653 between MPL 652 and SPL 654. SPL 654 has LET 654a such that LET 654a is recessed a second distance, similar to recess distance 364 of FIGS. 3E and 3F, from the pole tip 652a of MPL 652 at ABS 620 below ABS 620. The second distance of the LET 654a, similar to recess distance 364 of FIGS. 3E and 3F, given by the separation between ABS 620 and plane C-C, is greater than the first distance of the flare point, given by the separation between ABS 620 and plane A-A. Thus, stray magnetic flux, leakage magnetic flux, from SPL 654 may be reduced below a level sufficient to cause ATI. However, the interface 653 between MPL 652 and SPL 654 is non-planar, as LET 654a at the interface 653 between MPL 652 and SPL 654 includes the material-excess artifact 655 in MPL 652. The material-excess artifact 655 that intrudes into MPL 652 at LET 654a may interfere with performance of the flared portion 652c, and even the throat 652b of MPL 652 for a larger material-excess artifact 655 extending beyond trace of plane A-A. The material-excess artifact disrupts the continuity of the structure of the laminate of MPL 652, which may adversely affect magnetic properties of MPL 652, such as saturation magnetization, magnetic anisotropy and easy axis of magnetization. The material-excess artifact 655 may arise in the fabrication of the structures of write element 601, when certain procedures, such as a lift-off process, are used to form SPL 654. The lift-off process can result in residual stepped-pole-layer material being left behind at the junction between TFL 656 and LET 654a of SPL 654. Embodiments of the present invention, later discussed in the description of FIGS. 7 and 8A-8C, employ procedures to produce a write element of a PMR head, similar to write element 350a of PMR head 350 of FIGS. 3A-3F, such that a LET at the interface between a MPL and a SPL is without a material-excess artifact of stepped-pole-layer material intruding into the MPL, similar to the manner in which LET 354c at the interface 353 between MPL 352 and SPL 354 is without a material-excess artifact of stepped-pole-layer material intruding into MPL 352, as shown in FIG. 3F.

With further reference to FIG. 6, in order to more fully demonstrate the utility of embodiments of the present invention, SL 658 and sputtered alumina fill layer 692 form a substrate upon which TFL 656 and SPL 654 are formed. TFL 656 and SPL 654 are fabricated on the top surfaces of SL 658 and sputtered alumina fill layer 692. TFL 656 includes a non-taper-forming portion 656a and a taper-forming portion 656b; TFL 656 is composed of a non-magnetic material to facilitate the funneling effect on magnetic flux delivered to the pole tip 652a. The non-taper-forming portion 656a of TFL 656 extends from ABS 620 to the tip of LET 654a, demarcated by trace of plane C-C. The taper-forming portion 656b of TFL 656 extends from the trace of plane C-C, to the back of LET 654a, demarcated by trace of plane D-D. The taper-forming portion 656b of TFL 656 provides a template upon which LET 654a is formed. The taper-forming portion 656b of TFL 656 may have the shape of a ramp with a run length, rl, and a rise height, rh, which also corresponds to the thickness of TFL 656 and SPL 654. The slope of the ramp of taper-forming portion 656b is given by: rh/rl, which determines the taper angle, θ, 669. However, material-excess artifact 655 interferes with formation of LET 654a having reproducible and well-formed contour in the vicinity of tip of LET 654a, which may have unpredictable effects on delivery of magnetic flux from SPL 654 to MPL 652 in this critical region.

With further reference to FIG. 6, in order to more fully demonstrate the utility of embodiments of the present invention, SPL 654 includes LET 654a and a non-leading-edge-taper portion 654b. SL 658 may be magnetically coupled with SPL 654 across the interface between SL 658 and SPL 654. SPL 654 and TFL 656 form a substrate upon which MPL 652 is formed. MPL 652 is fabricated on the top surfaces of SPL 654 and TFL 656, demarcated by trace of plane G-G. As shown in FIG. 6, MPL 652 includes pole tip 652a, throat 652b and flared portion 652c. MPL 652 is magnetically coupled with SPL 654 across interface 653. However, material-excess artifact 655 may affect the delivery of magnetic flux from SPL 654 to MPL 652 in unpredictable ways across the critical interface 653, which can adversely affect yields of the wafer-level fabrication process. Also shown in FIG. 6, is an overcoating layer 690 that covers MPL 652. Overcoating layer 690 may include, without limitation thereto, a sputtered alumina layer.

A Method for Fabricating a Perpendicular-Magnetic-Recording Head with a Leading-Edge Taper of a Planarized Stepped-Pole Layer Having Greater Recess Distance than a Flare Point of a Main-Pole Layer

With reference now to FIG. 7, in accordance with embodiments of the present invention, a flow chart 700 is shown. The flow chart 700 illustrates a method for fabricating the PMR head 350 with the write element 350a of FIG. 3C including a MPL and a SPL such that an interface between the MPL and the SPL is planarized to be substantially flat over a LET of the SPL. At 710, a non-magnetic TFL is deposited. At 720, a taper-forming portion is fabricated in the non-magnetic TFL; the taper-forming portion is configured to recess a LET of a SPL by a second distance greater than a first distance of a flare point of a MPL below an ABS. At 730, the SPL is deposited to form the LET in the SPL over the taper-forming portion of the TFL. At 740, a sacrificial layer is deposited on the SPL. Depositing on the SPL the sacrificial layer may include depositing on the SPL a layer identical in composition to a composition of the SPL. At 750, a CMP process is applied to reduce a thickness of the sacrificial layer to a uniform thickness over the non-magnetic TFL and the SPL. At 760, a reactive-ion-milling process, referred to by the term of art “RAC-milling” process, is applied to define a surface of the SPL to serve as an interface between the MPL and the SPL. After 710, the method may further include depositing on the non-magnetic TFL an endpoint detection layer used for determining when to stop applying the RAC-milling process of 760 to define the surface of the SPL. Depositing on the non-magnetic TFL the endpoint detection layer may include depositing a layer of aluminum titanium oxide. During 760, the method may further include, detecting the endpoint detection layer using a secondary-ion-mass spectrometer (SIMS) to stop the RAC-milling process of 760. During 760, the method may also include using a mixture of fluoro-methane and argon as the constituents of a reactive atmosphere in applying the RAC-milling process to define the surface of the SPL to serve as the interface between the MPL and the SPL. At 770, the surface of SPL is planarized so that the interface between the MPL and the SPL is substantially flat over the LET of the SPL. In addition during 770, the method may further include selecting a ratio of fluoro-methane to argon for the reactive atmosphere to planarize the interface between the MPL and the SPL to be substantially flat over the LET of the SPL. Details of this method for fabricating the PMR head 350 with write element 350a of FIG. 3C are further elaborated in FIGS. 8A-8C, which are next described.

With reference now to FIG. 8A, in accordance with embodiments of the present invention, cross-sectional elevation views 800A of the write element 350a of the PMR head 350 of FIG. 3C show the initial stages in the wafer-level fabrication process of top portions of the write element 350a. FIG. 8A shows the fabrication of a non-magnetic TFL 816 with taper-forming portion 816b for forming LET 837a in SPL 837 (see FIG. 8B, at 845). At 810, alumina fill layer 812 and SL 814 are planarized using a CMP process to define a surface, demarcated by trace of plane F-F, that will later serve as an interface with SPL 837 (see FIG. 8B, at 835). As shown in 810, alumina fill layer 812 is separated from SL 814 by an interface between alumina fill layer 812 and SL 814, demarcated by trace of plane E-E. Note that throughout the following discussion of FIGS. 8A-8C, the traces of planes identified by A-A, B-B, C-C, D-D, E-E, F-F, G-G and H-H are common to FIGS. 8A-8C in which the traces of these planes appear. Moreover, the choice of the designations: A-A, B-B, C-C, D-D, E-E, F-F, G-G and H-H, is intended to identify the traces of these planes with identically designated traces of the planes in FIGS. 3C-3F, as FIGS. 8A-8C show the initial stages in the fabrication process of top portions of the write element 350a shown in FIGS. 3C-3F. However, to facilitate the discussion the labels for the various layers shown in FIGS. 8A-8C is not identical to those of FIGS. 3C-3F, because the various layers are in a partially fabricated state, not having the same final configuration as in the finished PMR head 350 shown in FIGS. 3C-3F.

With further reference to FIG. 8A, in accordance with embodiments of the present invention, at 815, a non-magnetic TFL 816 is deposited on alumina fill layer 812 and SL 814; a Durimide™ layer 817, a polyimide based photolithographic material layer, is deposited on the surface of TFL 816, demarcated by trace of plane G-G; and, a thin deep ultraviolet (DUV) photoresist layer 819 is deposited on the Durimide™ layer 817. Prior to deposition of the Durimide™ layer 817 in 815, an endpoint detection layer used for determining when to stop applying a RAC-milling process to define the surface of SPL 837 (see FIG. 8B, at 835) may be deposited on the non-magnetic TFL 816. The deposition on the non-magnetic TFL 816 of the endpoint detection layer may include depositing a layer of aluminum titanium oxide. At 815, the DUV photoresist layer 819 is photolithographically patterned to produce a mask, which defines the leading-edge of SPL 837 (see FIG. 8B, at 835), demarcated by trace of plane C-C. If a reactive-ion-etching (RIE) process is used to define the taper-forming portion of TFL 816, TFL 816 includes a non-magnetic sacrificial layer which may be selected from the group of materials consisting of tantalum, tantalum oxide, silicon nitride, silicon oxynitride, silicon oxide, or other RIE able non-magnetic materials. If an ion milling process is used to define the taper-forming portion of TFL 816, TFL 816 includes a non-magnetic sacrificial layer which may be selected from the group of materials consisting of alumina, rhodium, ruthenium, tantalum, or other non-magnetic materials. At 820, an image transfer process 822 is used to photolithographically pattern the Durimide™ layer 817 with the mask pattern of the DUV photoresist layer 819 to produce a hard-mask in the Durimide™ layer 817, which defines the leading-edge of SPL 837 (see FIG. 8B, at 835), demarcated by trace of plane C-C. The image transfer process of 820 may include an RIE process utilizing an oxygen-carbon or carbon dioxide gas chemistry. At 825, a taper-forming portion 816b of TFL 816 is formed using a RIE, or ion milling, process 827. The taper-forming portion 816b is configured to recess the LET 837a of SPL 837 (see FIG. 8B, at 835) by a second distance greater than a first distance of a flare point of MPL 852 (see FIG. 8C, at 860) below an ABS, demarcated by trace of plane I-I (see FIG. 8C, at 860). The TFL 816 includes a non-taper-forming portion 816a and taper-forming portion 816b. The taper-forming portion 816b of TFL 816 extends from the trace of plane C-C to the trace of plane D-D. The taper-forming portion 816b of TFL 816 provides a template upon which LET 837a (see FIG. 8B, at 835) is formed. The tip of LET 837a is demarcated by trace of plane C-C; and, the back of LET 837a is demarcated by trace of plane D-D. In one embodiment of the present invention, the taper-forming portion 816b of TFL 816 may have the shape of a ramp with a run length, rl, which corresponds to the separation between the trace of plane C-C and the trace of plane D-D, and a rise height, rh, which corresponds to the separation between the trace of plane F-F and the trace of plane G-G. The slope of the ramp of taper-forming portion 816b is given by: rh/rl, which determines the taper angle, θ, 829. The formation of the taper-forming portion 816b of TFL 816 is aligned to the top edge of a write-element electronic lapping guide (WELG), so that an accurate throat height of the MPL 852 (see FIG. 8C, at 860) can be defined in a subsequent lapping process.

With reference now to FIG. 8B, in accordance with embodiments of the present invention, cross-sectional elevation views 800B of the write element 350a of the PMR head 350 of FIG. 3C show the intermediate stages in the wafer-level fabrication process of top portions of the write element 350a. FIG. 8B shows the fabrication of SPL 837 and LET 837a in SPL 837. At 830, the DUV photoresist layer 819 and the Durimide™ layer 817 are stripped from the wafer in a hot N-Methylpyrrolidone (NMP) solution. At 835, SPL 837 is deposited, which forms LET 837a of SPL 837 over the taper-forming portion 816b of TFL 816. At this stage, SPL 837 includes a full film thickness of magnetic material including a portion which serves as a sacrificial layer identical in composition to a composition of SPL 837, which may include a high magnetic permeability material such as permalloy. The continued deposition of SPL 837 above the trace of plane G-G deposits on SPL 837 a layer that serves as the sacrificial layer, which the CMP process at 840 subsequently begins to remove and the RAC-milling process at 845 completes to remove. At 840, a CMP process is applied to reduce the thickness of the sacrificial layer to a uniform thickness over the non-magnetic TFL 816 and the SPL 837. The application of the CMP process at 840 prior to 845 allows for the achievement of better uniformity of the final thickness of SPL 837, after a subsequent reactive ion milling process at 845. At 845, a RAC-milling process is applied to define a surface of the SPL 837 to serve as an interface, demarcated by trace of plane G-G, between the MPL 852 (see FIG. 8C) and the SPL 837. SPL 837 includes LET 837a and a yoke portion 837b. For the RAC-milling process of 845, endpoint detection of the interface, demarcated by trace of plane G-G, may be accomplished by detecting an endpoint detection layer using a secondary-ion-mass spectrometer, at which point the RAC-milling process may be terminated. The RAC-milling process of 845 removes the portion of SPL 837, which serves as a sacrificial layer, and planarizes the surface of SPL 837 so that the interface between the MPL 852 (see FIG. 8C) and the SPL 837 is substantially flat over the LET 837a of the SPL 837 and free of artifacts such as shown in FIGS. 5 and 6. In the RAC-milling process of 845, a mixture of fluoro-methane and argon may be used as the constituents of a reactive atmosphere in applying the RAC-milling process to define the surface of SPL 837 to serve as the interface, demarcated by trace of plane G-G, between MPL 852 (see FIG. 8C) and the SPL 837. The RAC-milling process of 845 may include selecting a ratio of fluoro-methane to argon for the reactive atmosphere to planarize the surface of SPL 837 so that the interface between MPL 852 (see FIG. 8C) and SPL 837 is substantially flat over LET 837a of SPL 837.

With reference now to FIG. 8C, in accordance with embodiments of the present invention, cross-sectional elevation views 800C of the write element 350a of the PMR head 350 of FIG. 3C show the final stages in the wafer-level fabrication process of top portions of the write element 350a. FIG. 8B shows the fabrication of MPL 852 and an interface, demarcated by trace of plane G-G, between MPL 852 and SPL 837 that is substantially flat over LET 837a of SPL 837. At 850, MPL 852 is deposited on TFL 816 and SPL 837. An interface, demarcated by trace of plane G-G, is formed between MPL 852 and SPL 837. The interface between MPL 852 and SPL 837 is substantially flat over the LET 837a of the SPL 837 and free of artifacts such as shown in FIGS. 5 and 6, because the surface of SPL 837 is planarized at 845. MPL 852 is shown with horizontal hatch lines to indicate that MPL 852 may be a laminate formed of a multilayer structure including a plurality of repeated periods of cobalt-iron-on-alumina bilayers; alternatively, the multilayer structure may include a plurality of repeated periods of nickel-iron-on-alumina bilayers, a plurality of repeated periods of cobalt-iron-on-nickel-iron-on-alumina trilayers, or a plurality of repeated periods of cobalt-nickel-iron-on-alumina bilayers in which the amount of nickel is greater than the amount of cobalt. At 855, a hard-mask material 857 is deposited on top of MPL 852, demarcated by trace of plane H-H, and an image transfer process is used to form a hard mask, which is subsequently used to form the write pole of the write element including a throat 852b and a flared portion 852c of MPL 852 at 860. At 860, an ion milling process 862 is used to form the write pole of the write element. The ion milling process 862 also defines the sides of the flared portions of both SPL 837 and MPL 852. By adjusting the angle of incidence of the ion beam with respect to the wafer surface and sweeping the ion beam through an azimuthal sweep angle in the plane of the wafer surface, demarcated by trace of plane H-H, to the left and the right of the direction along the throat height of MPL 852 at different rates and for different dwell times, write elements with various shapes of MPL 852 and SPL 837 can be fabricated. The various shapes of MPL 852 and SPL 837 that can be fabricated by adjustment of these geometrical and temporal parameters include: a SPL with no flare-extension portions as shown in FIG. 3C; with a flare-extension portion having a squared corner and sides oriented perpendicular to the ABS, a so-called “vertical” flare-extension portion, as shown in FIG. 4A; and, with a flare-extension portion having a chamfered corner and side-walls oriented at a skewed angle to the ABS, a so-called “tapered” flare-extension portion, as shown in FIG. 4B. By adjusting the thickness of SPL 837 and ion milling, the flare-extension portion can be “tapered” or “vertical.” After 860 and wafer-level fabrication has been completed, a pole tip 852a of MPL 852 is defined in a lapping process where material to the left of the trace of plane I-I is removed.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A perpendicular-magnetic-recording head with leading-edge taper of a planarized stepped-pole layer having greater recess distance than a flare point of a main-pole layer, said perpendicular-magnetic-recording head comprising:
a write element comprising:
said main-pole layer having said flare point, said flare point recessed a first distance from a pole tip of said main-pole layer at an air-bearing surface below said air-bearing surface; and
said stepped-pole layer magnetically coupled with said main-pole layer across an interface between said main-pole layer and said stepped-pole layer, said stepped-pole layer having said leading-edge taper, said leading-edge taper recessed a second distance from said pole tip of said main-pole layer at an air-bearing surface below said air-bearing surface;
wherein said second distance of said leading-edge taper is greater than said first distance of said flare point; and
wherein a surface of said stepped-pole layer is planarized so that said interface between said main-pole layer and said stepped-pole layer is substantially flat over said leading-edge taper.

2. The perpendicular-magnetic-recording head recited in claim 1, wherein said stepped-pole layer increases delivery of magnetic flux to said pole tip of said main-pole layer.

3. The perpendicular-magnetic-recording head recited in claim 1, wherein said leading-edge taper at said interface between said main-pole layer and said stepped-pole layer is without a material-loss artifact in said stepped-pole layer.

4. The perpendicular-magnetic-recording head recited in claim 1, wherein said leading-edge taper at said interface between said main-pole layer and said stepped-pole layer is without a material-excess artifact of stepped-pole-layer material intruding into said main-pole layer.

5. The perpendicular-magnetic-recording head recited in claim 1, wherein a stray magnetic flux from said stepped-pole layer is reduced below a level sufficient to cause adjacent track interference.

6. The perpendicular-magnetic-recording head recited in claim 1, wherein said stepped-pole layer substantially replicates a shape of a flared portion of said main-pole layer within a plane of said stepped-pole layer under said flared portion of said main-pole layer to reduce stray magnetic flux from said stepped-pole layer below a level sufficient to cause adjacent track interference.

7. The perpendicular-magnetic-recording head recited in claim 1, wherein said stepped-pole layer further comprises flare-extension portions, said flare-extension portions of said stepped-pole layer extending laterally in a direction parallel to an air-bearing surface of said perpendicular-magnetic-recording head within a plane of said stepped-pole layer beyond a flared portion of said main-pole layer to increase delivery of magnetic flux to said pole tip of said main-pole layer;
wherein said flare-extension portions are selected from the group consisting of a flare-extension portion having a substantially squared corner in a plane of said stepped-pole layer with a side oriented perpendicular to said air-bearing surface and a flare-extension portion having a chamfered corner in a plane of said stepped-pole layer with a side oriented at a skewed angle to said air-bearing surface.

8. A hard-disk drive incorporating a perpendicular-magnetic-recording head with leading-edge taper of a planarized stepped-pole layer having greater recess distance than a flare point of a main-pole layer, said hard-disk drive comprising:
a perpendicular-magnetic-recording disk rotatably mounted on a spindle;
an arm; and
a slider attached to said arm, said slider comprising:
a perpendicular-magnetic-recording head for writing data to and reading data from said perpendicular-magnetic-recording disk; and
a load beam attached at a gimbal portion of said load beam to said perpendicular-magnetic-recording head, said slider including said perpendicular-magnetic-recording head integrally attached at a trailing-edge portion of said slider;
wherein said perpendicular-magnetic-recording head comprises:
a write element comprising:
said main-pole layer having said flare point, said flare point recessed a first distance from a pole tip of said main-pole layer at an air-bearing surface below said air-bearing surface; and
said stepped-pole layer magnetically coupled with said main-pole layer across an interface between said main-pole layer and said stepped-pole layer, said stepped-pole layer having said leading-edge taper, said leading-edge taper recessed a second distance from said pole tip of said main-pole layer at an air-bearing surface below said air-bearing surface;
wherein said second distance of said leading-edge taper is greater than said first distance of said flare point; and
wherein a surface of said stepped-pole layer is planarized so that said interface between said main-pole layer and said stepped-pole layer is substantially flat over said leading-edge taper.

9. The hard-disk drive recited in claim 8, wherein said stepped-pole layer increases delivery of magnetic flux to said pole tip of said main-pole layer.

10. The hard-disk drive recited in claim 8, wherein said leading-edge taper at said interface between said main-pole layer and said stepped-pole layer is without a material-loss artifact in said stepped-pole layer.

11. The hard-disk drive recited in claim 8, wherein said leading-edge taper at said interface between said main-pole layer and said stepped-pole layer is without a material-excess artifact of stepped-pole-layer material intruding into said main-pole layer.

12. The hard-disk drive recited in claim 8, wherein a stray magnetic flux from said stepped-pole layer is reduced below a level sufficient to cause adjacent track interference.

13. The hard-disk drive recited in claim 8, wherein said stepped-pole layer substantially replicates a shape of a flared portion of said main-pole layer within a plane of said stepped-pole layer under said flared portion of said main-pole layer to reduce stray magnetic flux from said stepped-pole layer below a level sufficient to cause adjacent track interference.

14. The hard-disk drive recited in claim 8, wherein said stepped-pole layer further comprises flare-extension portions, said flare-extension portions of said stepped-pole layer extending laterally in a direction parallel to an air-bearing surface of said perpendicular-magnetic-recording head within a plane of said stepped-pole layer beyond a flared portion of said main-pole layer to increase delivery of magnetic flux to said pole tip of said main-pole layer;
wherein said flare-extension portions are selected from the group consisting of a flare-extension portion having a substantially squared corner in a plane of said stepped-pole layer with a side oriented perpendicular to said air-bearing surface and a flare-extension portion having a chamfered corner in a plane of said stepped-pole layer with a side oriented at a skewed angle to said air-bearing surface.

15. A method for fabricating a perpendicular-magnetic-recording head with leading-edge taper of a planarized stepped-pole layer having greater recess distance than a flare point of a main-pole layer, said method comprising:
depositing a non-magnetic taper-forming layer;
fabricating a taper-forming portion in said non-magnetic taper-forming layer, said taper-forming portion configured to recess a leading-edge taper of a stepped-pole layer by a second distance greater than a first distance of a flare point of a main-pole layer below an air-bearing surface;
depositing a stepped-pole layer to form a leading-edge taper in said stepped-pole layer over said taper-forming portion of said taper-forming layer;
depositing on said stepped-pole layer a sacrificial layer;
applying a chemical-mechanical polishing process to reduce a thickness of said sacrificial layer to a uniform thickness over said non-magnetic taper-forming layer and said stepped-pole layer;
applying a reactive-ion-milling process to define a surface of said stepped-pole layer to serve as an interface between said main-pole layer and said stepped-pole layer; and
planarizing said surface of said stepped-pole layer so that said interface between said main-pole layer and said stepped-pole layer is substantially flat over said leading-edge taper of said stepped-pole layer.

16. The method recited in claim 15, wherein said depositing on said stepped-pole layer said sacrificial layer further comprises depositing on said stepped-pole layer a layer identical in composition to a composition of said stepped-pole layer.

17. The method recited in claim 15, wherein said method further comprises:
depositing on said non-magnetic taper-forming layer an endpoint detection layer used for determining when to stop said applying said reactive-ion-milling process to define said surface of said stepped-pole layer.

18. The method recited in claim 17, wherein said depositing on said non-magnetic taper-forming layer said endpoint detection layer further comprises depositing a layer of aluminum titanium oxide.

19. The method recited in claim 17, further comprising:
detecting said endpoint detection layer using a secondary-ion-mass spectrometer.

20. The method recited in claim 15, further comprising:
using a mixture of fluoro-methane and argon as the constituents of a reactive atmosphere in said applying said reactive-ion-milling process to define said surface of said stepped-pole layer to serve as said interface between said main-pole layer and said stepped-pole layer.

21. The method recited in claim 20, further comprising:
selecting a ratio of fluoro-methane to argon for said reactive atmosphere to planarize said surface of said stepped-pole layer so that said interface between said main-pole layer and said stepped-pole layer is substantially flat over said leading-edge taper of said stepped-pole layer.
